(19) United States
(12) Patent Application Publication
(10) Pub. No.: US 2004/0179365 A1
(43) Pub. Date: Sep. 16, 2004

(54) Color coded home visitor greeting lamp system

(76) Inventor: Chang Soo Kim, Garden Grove, CA (US)

Correspondence Address: PARK & SUTTON LLP, 3255 WILSHIRE BLVD, SUITE 1110, LOS ANGELES, CA, 90010, US

(21) Appl. No.: 10/798,504

(22) Filed: Mar. 11, 2004

Related U.S. Application Data
(60) Provisional application No. 60/454,157, filed on Mar. 12, 2003.
(60) Provisional application No. 60/455,540, filed on Mar. 18, 2003.
(60) Provisional application No. 60/454,156, filed on Mar. 12, 2003.

(51) Int. Cl. F21V 17/06

(52) U.S. Cl. 362/433; 362/231; 362/230; 362/240; 362/431; 362/802; 362/408

(57) ABSTRACT

A color coded home visitor greeting lamp system comprises a circuit board having an electric port with the circuit board connected to a controller, a light bulb having a bulb base detachably mounted in the port where the light bulb is blinkable under control of the controller, a flashing member removably provided between the bulb base and the port, and a substantially transparent covering detachably mounted over the board. The covering has hook rails and slide panels so that the slide panels are detachably slid in the hook rails.

### CROSS REFERENCES RELATED TO THIS APPLICATION

The applicant claims the benefits and priorities of the U.S. provisional application Nos. 60/454/157 filed on Mar. 12, 2003; 60/455,540 filed on Mar. 18, 2003; and 60/454,156 filed on Mar. 12, 2003.

### BACKGROUND OF INVENTION

The present invention relates to a multi-purpose lamp. More particularly, the present invention relates to a color coded home visitor greeting lamp system enabling a home visitor to make a quick and convenient consensus with the inviting home resident.

Finding a house is never an easy job to first time home visitors. Maps do not reflect road slopes that confuse those finding a house while driving a vehicle, and street signs are hardly visible under trees. Especially, for those visiting at night, street name signs are never located close to street lights so making a lap or two around the new area sitting behind a wheel would be minimally required for the first time visitors.

What is in strong demand is a device that allows a visitor to easily spot and locate the inviting house. Installing light bulbs near the house to brighten the home number hardly help a visitor because even the experienced visitor sitting behind the wheel is not usually expected to simultaneously perform the driving and frequently turning the head to spot the home number that stands many times on an unexpected location.

Another demand is an application of a color coding or combination bulbs to differentiate and identify the house or residence to find, for example, by allowing each house to reserve its own color combinations, color codes or signal symbols.

### SUMMARY OF THE INVENTION

The present invention is contrived to overcome conventional disadvantages. Accordingly, it is an object of the present invention is to provide an improved home visitor greeting lamp system enabling a home visitor to make a quick and convenient consensus with the inviting home resident.

Another object is to provide a house an additional home identity to supplement the hard-to-find street number. A further object is to set a standard light-blinking combination system for residential neighbors to share.

To achieve these and other objects, the color coded home visitor greeting lamp system comprises a circuit board having an electric port with the circuit board connected to a controller. A light bulb having a bulb base is detachably mounted in the port and blinkable under control of the controller. A flashing member is removably provided between the bulb base and the port and a substantially transparent covering is detachably mounted over the board to protect the light bulb and the circuit board so that the covering has hook rails and slide panels so that the slide panels are detachably slid in the hook rails.

In a preferred version, the home visitor greeting lamp system comprises a plurality of electric ports so each bulb base is detachably mounted in a corresponding one of the ports. Here, the colored light bulbs are blinkable under control of the controller and at least two different colors are incorporated in the light bulbs.

For a better performance, the substantially transparent covering may be detachably mounted over the board to protect the light bulb and the circuit board, and the flashing member may be incorporated in the circuit board to control bulb blinking sequences and intervals.

The slide panels may be colored glasses with the covering two-tone colored. It is also preferred that the flashing member is a bulb flasher and the light bulb is colored. The controller is an in-house controller installed indoors. A decoration cap detachably mounted on top of the covering. Selectively, the colored light bulbs may be set to alternately blink. The greeting lamp system is formed in a portable format.

The advantages of the present invention are numerous. First, the color coded combination mechanism of blinking and flashing effectively guides a visitor to easily find the hosting house with a warm welcome message of the inviting host, thereby enhancing user satisfaction while maximizing product reliability. Secondly, the in-house light control system allows a host to control the combination of the blinking and flashing and to communicate with the visitor sitting behind the wheel to the last minute so as to provide a visual confirmation of the house location, thereby improving product applicability and usability. Thirdly, the provision of the decoration cap together with the glass covering of the lamp system enables its user to expand its application from outdoor lighting and guiding to outdoor decoration and from practical use to esthetic adaptation, thereby aesthetically culminating decorative expression while transferring a warm welcome message to the visitor.

Although the present invention is briefly summarized, the fuller understanding of the invention can be obtained by the following drawings, detailed description and appended claims.

### BRIEF DESCRIPTION OF THE DRAWINGS

The above objects and advantages will be more apparent by describing the present invention with reference to the accompanying reference drawings, in which:

FIG. 1 is a view showing a color coded home visitor greeting lamp according to the present invention;

FIG. 2 is a partially exploded view showing construction of the present invention;

FIG. 3 is a schematic plan view showing the bulb and panel alignment of the present invention; and

FIG. 4 is a flowchart showing operation mechanism of the present invention.

### DETAILED DESCRIPTION OF THE PREFERRED EMBODIMENTS

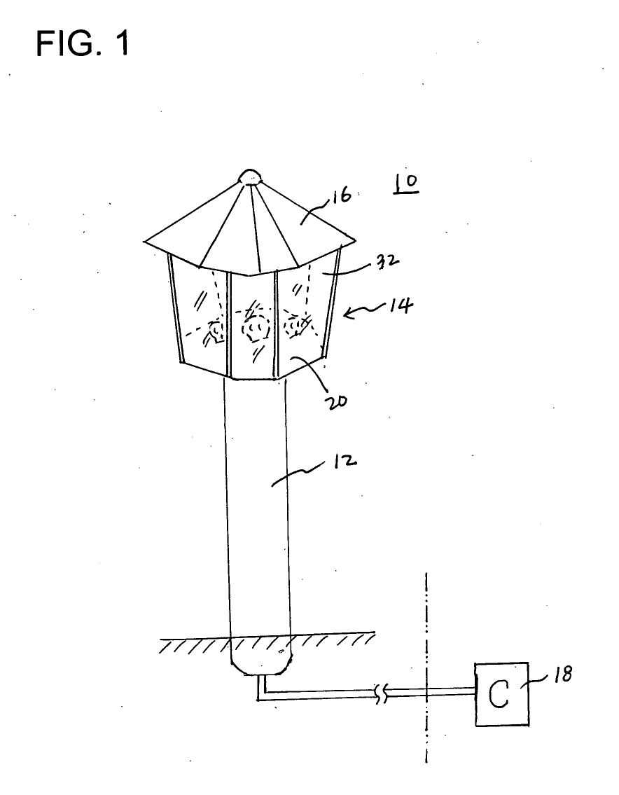

FIG. 1 shows a color coded home visitor greeting lamp system 10 where a post 12 stands supporting a lamp body 14 with a decoration cap mounted 16 on top of the lamp body 14. The earthed post 12 also serves to electrically connect the lamp body 14 to an in-house controller 18.

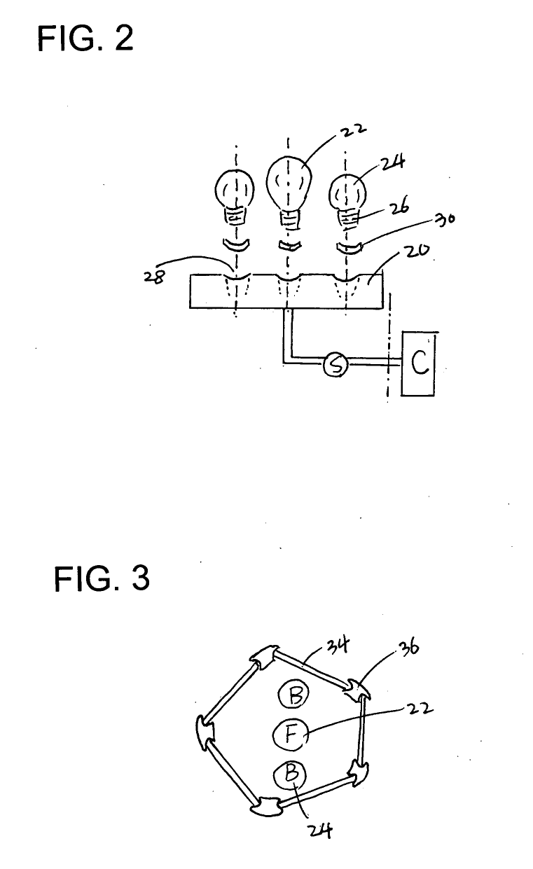

FIG. 2 shows the electric connection mechanism of the lamp body 14 to the controller 18, and FIG. 3 shows the lamp body 14 viewed from atop without the decoration cap 16. As shown therein, a circuit board 20 having one or more electric ports are installed inside the lamp body 14. The circuit board 20 is electrically connected to the controller 18 through the post 12. In an embodiment, the lamp body 20 may be formed in a portable format to improve usability. For example, the greeting lamp system 10 having the lamp body 14 in a portable format may be taken out from indoor storage and installed outdoors when a guest is scheduled to visit.

In a preferred mode, a plurality of light bulbs 22, 24 each having a bulb base 26 is detachably provided on the circuit board 20. Specifically, each bulb base 24 is detachably mounted in a corresponding port 28. In this construction, the light bulbs 22, 24 are formed blinkable under control of the controller 18 installed indoors.

For a better performance, a flashing member 30 is removably provided between each bulb base 26 and the corresponding port 28. The flashing member 30 may be formed of one selected from a bulb flasher and other types of flashing devices.

In order to effectively protect the bulbs 22, 24 and the circuit board 20 the lamp body 14 includes a substantially transparent covering 32 detachably mounted over the board 20 to protect the light bulbs 22, 24 and the circuit board 20. Here, the covering 32 is preferably formed of a plurality of panels 34 supported by hook rails 36 so that the slide panels 34 are detachably slid in the hook rails 36.

Preferably, each bulb 22, 24 is selectively colored and in a better version at least two different colors are incorporated in the light bulbs 22, 24. The flashing member 30 may be also incorporated in the circuit board 20 to control bulb blinking sequences and intervals in cooperation with the controller 18. A switch S may also be selectively provided between the lamp body 14 and the controller 18 for a safety measure.

The slide panels 34 may be either colored glasses or acrylic plates. To improve functionality of the greeting lamp system 10 the covering 32 may be two-tone colored. That is, the slide panels 34 may adopt two or more of the selected colors. The decoration cap 16 is detachably mounted on top of the covering 32 to fully cover the slide panels 34 and the rails 36 for aesthetic purposes as well as utility purposes. The colored light bulbs 22, 24 are set to alternately blink under control of the controller 18 for the best performance.

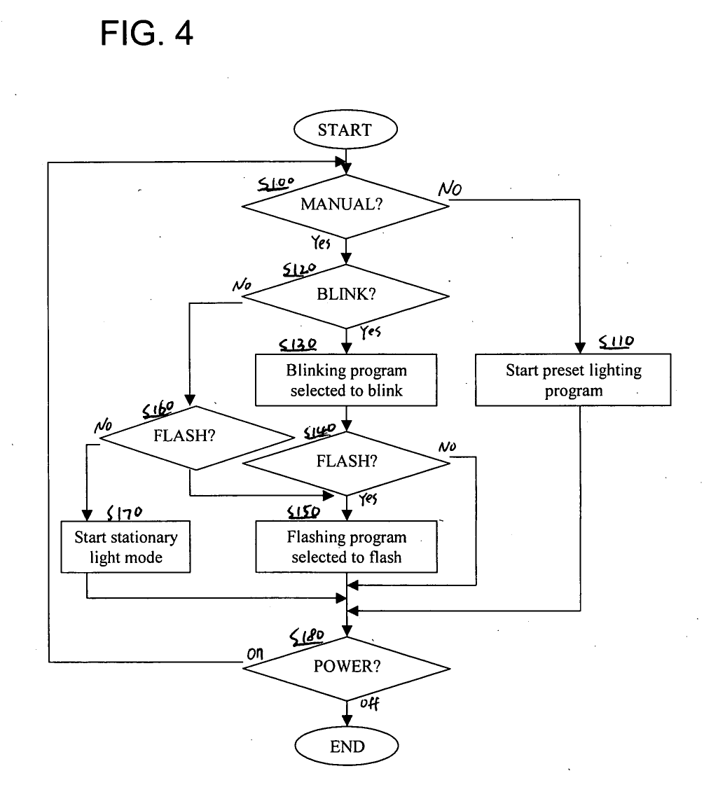

FIG. 4 is a flowchart showing how to control the controller 18 in a variety of control modes. As shown therein, when the controller 18 is not manually controlled a preset lighting program automatically starts so that the bulbs 22, 24 perform a preset combination of the bulb blinking and/or flashing in steps S110-S110. For example, three bulbs are linearly aligned on the circuit board 20, the centered bulb 22 flashes whereas the other front and rear bulbs blink according to the present program.

When the controller 18 is manually controlled to allow the blinking to begin then the user selects one of the blinking programs (S130). Meanwhile, if the blinking is deselected but flashing is selected the selected flashing is performed S150). If neither of the blinking and the flashing is selected the controller 18 is set to start stationary light mode (S170) to maintain bulb lighting with neither blinking nor flashing. Also, the blinking function selected to perform one of the blinking programs (S120-S130) may be immediately followed by the flashing function to simultaneously perform the flashing according to one of the flashing programs (S140-S150) as long as electric power remains turned on.

As discussed above, an advantage of the present invention is that the color coded combination mechanism of blinking and flashing effectively guides a visitor to easily find the hosting house with a warm welcome message of the inviting host, thereby enhancing user satisfaction while maximizing product reliability. Further, the inhouse light control system 10 allows a host to control the combination of the blinking and flashing and to communicate with the visitor sitting behind the wheel to the last minute so as to provide a visual confirmation of the house location, thereby improving product applicability and usability. In addition, the provision of the decoration cap 16 together with the glass covering 32 of the lamp system 10 enables its user to expand its application from outdoor lighting and guiding to outdoor decoration and from practical use to esthetic adaptation, thereby aesthetically culminating decorative expression while transferring a warm welcome message to the visitor.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. A color coded home visitor greeting lamp system comprising:
a) a circuit board having an electric port, wherein the circuit board is connected to a controller;
b) a light bulb having a bulb base, wherein the bulb base is detachably mounted in the port, wherein the light bulb is blinkable under control of the controller;
c) a flashing member removably provided between the bulb base and the port; and
d) a substantially transparent covering detachably mounted over the board to protect the light bulb and the circuit board, wherein the covering has hook rails and slide panels so that the slide panels are detachably slid in the hook rails.

2. The visitor greeting lamp system of claim 1 further comprising a decoration cap detachably mounted on top of the covering.

3. The visitor greeting lamp system of claim 1 wherein the slide panels are colored glasses.

4. The visitor greeting lamp system of claim 1 wherein the covering is two-tone colored.

5. The visitor greeting lamp system of claim 1 wherein the flashing member is a bulb flasher.

6. The visitor greeting lamp system of claim 1 wherein the light bulb is colored.

7. The visitor greeting lamp system of claim 1 wherein the controller is an in-house controller installed indoors.

8. A color coded home visitor greeting lamp system comprising:
a) a circuit board having a plurality of electric ports, wherein the circuit board is connected to an in-house controller;
b) colored light bulbs each having a bulb base, wherein said each bulb base is detachably mounted in a corresponding one of the ports, wherein the colored light bulbs are blinkable under control of the controller, wherein at least two different colors are incorporated in the light bulbs;
c) a flashing member removably provided between one of the bulb bases and one of the ports; and
d) a substantially transparent covering detachably mounted over the board to protect the light bulb and the circuit board, wherein the covering has hook rails and slide panels so that the slide panels are detachably slid in the hook rails.

9. The visitor greeting lamp system of claim 8 further comprising a decoration cap detachably mounted on top of the covering.

10. The visitor greeting lamp system of claim 8 wherein the slide panels are colored glasses.

11. The visitor greeting lamp system of claim 8 wherein the covering is two-tone colored.

12. The visitor greeting lamp system of claim 8 wherein the colored light bulbs are set to alternately blink.

13. The visitor greeting lamp system of claim 8 wherein the flashing member is a bulb flasher.

14. A color coded home visitor greeting lamp system comprising:
a) a circuit board having a plurality of electric ports, wherein the circuit board is connected to an in-house controller;
b) colored light bulbs each having a bulb base, wherein said each bulb base is detachably mounted in a corresponding one of the ports, wherein the colored light bulbs are blinkable under control of the controller, wherein at least two different colors are incorporated in the light bulbs;
c) a flashing member incorporated in the circuit board to control bulb blinking sequences and intervals; and
d) a substantially transparent covering detachably mounted over the board to protect the light bulb and the circuit board, wherein the covering has hook rails and slide panels so that the slide panels are detachably slid in the hook rails.

15. The visitor greeting lamp system of claim 14 further comprising a decoration cap detachably mounted on top of the covering.

16. The visitor greeting lamp system of claim 14 wherein the slide panels are colored glasses.

17. The visitor greeting lamp system of claim 14 wherein the covering is two-tone colored.

18. The visitor greeting lamp system of claim 14 wherein the colored light bulbs are set to alternately blink.

19. The visitor greeting lamp system of claim 14 wherein the system is portable.

20. The visitor greeting lamp system of claim 14 wherein the flashing member is a bulb flasher.
